(19) United States
(12) Patent Application Publication
(10) Pub. No.: US 2003/0164579 A1
(43) Pub. Date: Sep. 4, 2003

(54) Method of making impact-resistant modified thermoplastic materials

(75) Inventors: Gunter Prautzsch, Koln (DE); Erwin Burkle, Benediktbeuern (DE); Bernd Klotz, Gunding/Bergkirchen (DE); Hans Wobbe, Herrsching (DE); Walter Wohlrab, Weissenburg (DE)

Correspondence Address: Henry M. Feiereisen, Suite 3220, 350 Fifth Avenue, New York, NY, 10118, US

(73) Assignee: KRAUSS-MAFFEI KUNSTSTOFFTECHNIK GMBH, Munchen (DE)

(21) Appl. No.: 10/345,087

(22) Filed: Jan. 15, 2003

(30) Foreign Application Priority Data
Jan. 15, 2002 (DE) 102 01 291.1-16

(51) Int. Cl. B29C 45/00; B29C 45/47

(52) U.S. Cl. 264/328.18; 264/328.19

(57) ABSTRACT

In a method of making impact-resistant modified thermoplastic materials, thermoplastic material is introduced in a continuously operating twin-screw extruder having two screws rotating in a same direction and plasticized. Admixed to the thermoplastic material in the extruder at a location well downstream of the feed area of the thermoplastic material is an additive, e.g. impact-resistant modification agent, reinforcing agent, or alloying agent, to produce an extrudate which is conveyed for injection into an injection mold alternately via two injection cylinders or via a storage cylinder and one injection cylinder.

### CROSS-REFERENCES TO RELATED APPLICATIONS

This application claims the priority of German Patent Application, Serial No. 102 01 291.1-16, filed Jan. 15, 2002, pursuant to 35 U.S.C. 119(a)-(d), the disclosure of which is incorporated herein by reference.

### BACKGROUND OF THE INVENTION

The present invention relates to a method of making impact-resistant modified thermoplastic materials.

Manufacture of such materials by way of conventional injection molding processes results in a limited toughness because of the material involved and because the way the process is configured. Damage to additives is especially a concern in conventional injection molding machines with intermittently operating plasticizing unit as a consequence of repeated melting in an upstream compounding process with granulation and subsequent re-heating and injection molding, and as a consequence of long residence times.

German patent publications DE 38 24 455 and DE 41 42 577 describe methods of making thermoplastic molding material. Common to both methods is the need for shaping the molding materials by heating them in a second zone (so-called second heat).

It would therefore be desirable and advantageous to provide an improved method of making impact-resistant modified thermoplastic materials to obviate prior art shortcomings.

### SUMMARY OF THE INVENTION

According to one aspect of the present invention, a method of making impact-resistant modified thermoplastic materials, includes the steps of introducing a thermoplastic material in a continuously operating twin-screw extruder having two screws rotating in a same direction, plasticizing the thermoplastic material in the extruder, admixing to the thermoplastic material in the extruder at least one additive selected from the group consisting of impact-resistant modification agents, reinforcing agents and alloying agents, to produce an extrudate, and conveying the extrudate for injection into a mold via an arrangement selected from the group consisting of arrangement of two injection cylinders, whereby the extrudate is fed alternatingly to the two injection cylinders, and arrangement of a storage cylinder and an injection cylinder, whereby the extrudate is fed alternatingly to the storage cylinder and the injection cylinder.

The present invention resolves prior art problems by ensuring a good distribution of the impact-resistant modifying agents, reinforcing agents or other alloying agents in the finished article, without damage to these sensitive agents or adversely affect their dispersion in the matrix. As a result, the finished articles exhibit good mechanical properties.

Instead of using an intermittently or discontinuously operating single screw plasticizing unit, the use of a continuously operating twin-screw extruder with screws. rotating in same direction is proposed. A specific construction and manner of a twin-screw extruder of this type is fully described in commonly assigned copending patent application by a different inventive entity, entitled “Method of and Apparatus for Producing Injection-Molded Parts Reinforced with Long Fibers”, filed Jun. 5, 2001, the entire specification and drawings of which are expressly incorporated herein by reference.

In accordance with the present invention, the extruder continuously plasticizes the material in a gentle manner. The material flow is alternatingly conveyed to two injection cylinders or to a storage cylinder and an injection cylinder. In this way one cylinder is available and can be charged with plasticized material while the other cylinder is operated for effecting the actual injection process and after-pressure at the same time. This principle, in concert with side feeders, thus results in a very late introduction of the reinforcing agents or additives or “additive packets” as well as fillers into the melt stream to thereby ensure superior mixing, even when complex polymer mixtures are involved.

In this way, the following finished articles can be directly produced by the method according to the present invention:

physically mixed partially crosslinked elastomers (e.g. EPDM) with partly crystallized plastics (e.g. PP, PA, PBT, PET);

articles which are almost free of distortion and made of PBT/ASA or PBT/SAN mixtures, e.g. for electrotechnical components (safety boxes);

impact-resistant articles of PP/EPDM, such as, e.g., vehicle bumpers;

impact-resistant articles of PA6/EPDM, such as, e.g., ski bindings or parts of ski boots;

impact-resistant articles of PA66/EPDM, such as, e.g., sports equipments;

impact-resistant -articles of PA66/EPDM with glass fiber reinforcement, such as, e.g., cable connector/insulator in high-voltage land lines;

articles which are almost free of distortion and made of plastic with mineral powder reinforcement, e.g. wheel trim caps;

articles which are almost free of distortion and made of plastic with glass bead reinforcement, e.g. electronic casings, plug-type connectors;

articles which are almost free of distortion and have increased strength and made of fiber/mineral powder mixtures, such as, e.g., cylinder head covers or styling covers in the engine compartment;

articles which are almost free of distortion and have fiber reinforcement and impact modification, such as, e.g., wind deflectors used for vehicle sunroofs;

structural parts of plastic with wood dust filling, e.g., cover for spare wheel, trunk side lining;

structural parts of plastic alloys with low thermal expansion coefficient, e.g., PBT/SAN for exterior parts of the vehicle body;

structural parts of sintered powders with a binder for subsequent sintering in powder metallurgy as well as ceramics production, e.g., heavy-metal tungsten for tool cutting or porcelain for electric insulators;

structural parts with metallic powders or graphite powder in a polymer matrix for decreasing the inherent electrical resistance, e.g., antistatic components in gas heating plants, screening components in microelectronic devices;

structural parts of reactively or physically foamed thermoplastic materials, such as, e.g., interior vehicle parts, noise protection walls;

structural parts with fractions of pigments, such as, e.g., through-dyed trash containers;

structural parts with fractions of flame protection agents, such as, e.g., safety girders for the construction industry;

structural parts with fractions of stabilizing agents and antioxidants, such as, e.g., outer vehicle skin.

According to another feature of the present invention, the additives are fed at a location of the extruder downstream of the introduction of the thermoplastic material.

### BRIEF DESCRIPTION OF THE DRAWING

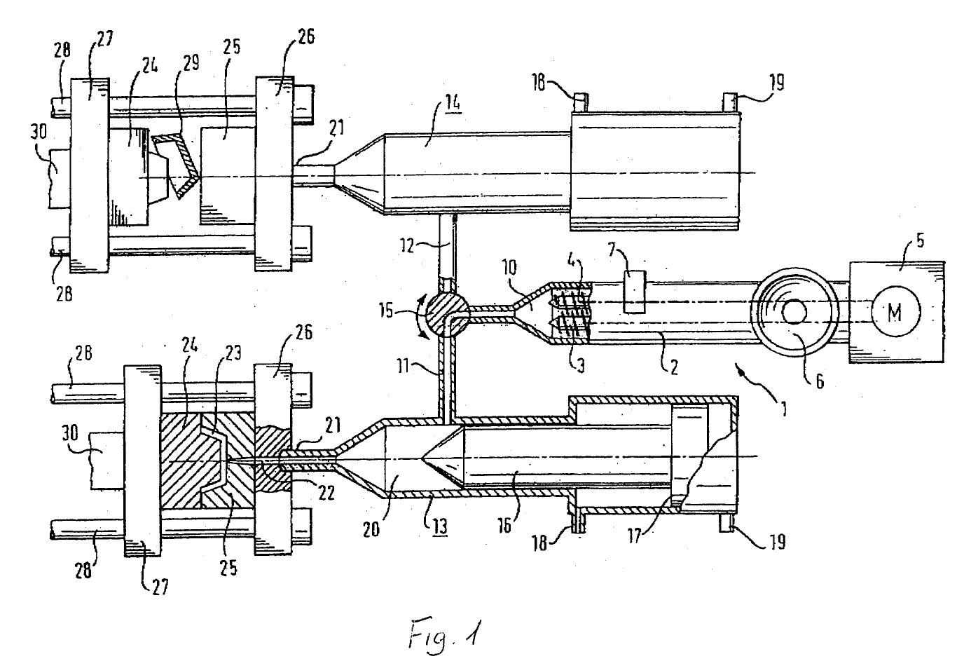

Other features and advantages of the present invention will be more readily apparent upon reading the following description of currently preferred exemplified embodiments of the invention with reference to the accompanying drawing, in which the sole FIG. 1 is an exemplary partly sectional illustration of an injection molding arrangement embodying the subject matter according to the present invention.

### DETAILED DESCRIPTION OF PREFERRED EMBODIMENTS

The depicted embodiment is to be understood as illustrative of the invention and not as limiting in any way.

Turning now to FIG. 1, there is shown an exemplary partly sectional illustration of an injection molding arrangement which includes a twin-screw extruder, generally designated by reference numeral 1 and referred to as a so-called compounder. The extruder 1 has a barrel 2 which accommodated two screws 3, 4 which rotate in a same direction and mesh with one another. The screws 3, 4 are operated continuously by a rotary drive 5 having a motor M. Arranged on the barrel 2 is a feed hopper 6 for supply of thermoplastic granulate into the barrel 2, whereby the thermoplastic material is plasticized by the rotating screws 3, 4 and advanced to an anterior screw chamber 10 which is fluidly connected via two branches 11, 12 to two injection 13, 14. A flow control valve 15 regulates the flow of plasticized melt from the anterior screw chamber 10 in alternating sequence to an anterior cylinder space 20 of the injection cylinder 13 or to an anterior cylinder space 20 of the injection cylinder 14.

As shown in FIG. 1 by the partially sectional illustration of the lower one of the injection cylinders 13, 14, each of the injection cylinders 13, 14 includes an injection plunger 16 and a hydraulic operating plunger 17 which is acted upon alternatingly via hydraulic ports 18, 19 by a pressure fluid conveyed by a, not shown, pump for providing a predetermined pressure profile. The cylinder spaces 20 of the injection cylinders 13, 14 are each fluidly connected via an injection nozzle 21 and a sprue channel 22 with a mold cavity 23 of an injection mold. Each injection mold has a fixed mold mounting plate 26 for carrying mold half 25, and a moving mold mounting plate 27 for carrying mold half 24, with guide rods 28 extending between the mounting plates 26, 27. The mold mounting plate 27 is moved to the opening and closing positions by a hydraulic unit 30, which is shown only partially.

When, for example, the cylinder space 20 of the injection cylinder 13 is filled with material, the control valve 15 is reversed to enable a flow of plasticized material via branch 12 into the cylinder space 20 of the injection cylinder 14. In this way, the extruder 1 can be continuously operated. Material in the cylinder space 20 of the injection cylinder 13 is injected into the cavity 23 between the mold halves 24, 25 of the injection mold through advance movement of the piston 16. As an article is produced in the injection mold interacting with the injection cylinder 13, the cylinder space 20 of the injection cylinder 14 is now fed with plasticized material from the extruder 1 via branch 12, while a finished article 29 is withdrawn from the injection mold interacting with the injection cylinder 14.

In accordance with the present invention, additives., such as impact-resistant modification agents, reinforcing agents or alloying agents, are introduced into the plasticized material in the barrel 2 via a side feeder 7. Hereby, the position of the side feeder 7 is selected as illustrated. Suitably, the side feeder 7 is shifted downstream in direction of the anterior screw space 10 of the extruder 1 to such a position that the residence time of the additives in the extruder 1 is long enough to ensure a sufficient mixing by means of the screws 3, 4, and yet short enough to prevent damage to the additives as a consequence of the mixing process.

While the present invention has been described in connection with an injection molding arrangement comprised of two injection cylinders 13, 14, the principles described herein are equally applicable to any other type of injection molding arrangement which generally follows the concepts outlined here. For example, instead of use two injection cylinders, the injection molding arrangement may include one injection cylinder and a storage cylinder for temporarily storing plasticized material until fed to the injection cylinder. Also in this configuration is it possible to operate the extruder continuously.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method of making impact-resistant modified thermoplastic materials, comprising the steps of:
introducing a thermoplastic material into a continuously operating twin-screw extruder having two screws rotating in a same direction;
plasticizing the thermoplastic material in the extruder;
admixing to the thermoplastic material in the extruder at least one additive selected from the group consisting of impact-resistant modification agents, reinforcing agents and alloying agents, to produce an extrudate; and
conveying the extrudate for injection into a mold via an arrangement selected from the group consisting of arrangement of two injection cylinders, whereby the extrudate is fed alternatingly to the two injection cylinders, and arrangement of a storage cylinder and an injection cylinder, whereby the extrudate is fed alternatingly to the storage cylinder and the injection cylinder.

2. The method of claim 1, wherein the admixing step is realized at a location of the extruder downstream of an introduction of the thermoplastic material.

3. The method of claim 1, wherein the admixing step is realized via a side feeder.

4. A method of making impact-resistant modified thermoplastic material, comprising the steps of:
introducing a thermoplastic material at an entry point into a twin-screw extruder having two screws rotating in a same direction plasticizing the thermoplastic material in the extruder as the thermoplastic material is advanced to an anterior screw space;
admixing to the thermoplastic material in the extruder at least one additive selected from the group consisting of impact-resistant modification agents, reinforcing agents and alloying agents, at a location in proximity of the anterior screw space sufficient to realize a proper mixture of the additive with the thermoplastic material while keeping a residence time of the additive in the extruder to a minimum, thereby producing an extrudate; and
selectively conveying the extrudate to a pair of cylinders for further processing and to enable a continuous operation of the extruder.
